(19) United States
(12) Patent Application Publication
(10) Pub. No.: US 2025/0080684 A1
(43) Pub. Date: Mar. 6, 2025

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventors: Seiji SHIRAKI, Kanagawa (JP); Masahiko MIZUMURA, Kanagawa (JP); Nagamasa MISU, Kanagawa (JP); Yushiro TANAKA, Kanagawa (JP); Saki SHIDARA, Kanagawa (JP)

(73) Assignee: FUJIFILM Business Innovation Corp., Tokyo (JP)

(21) Appl. No.: 18/585,014

(22) Filed: Feb. 22, 2024

(30) Foreign Application Priority Data
Sep. 5, 2023 (JP) 2023-143502

(51) Int. Cl. H04N 1/62; H04N 1/50

(52) U.S. Cl. CPC H04N 1/62; H04N 1/502

(57) ABSTRACT

An information processing system includes a processor configured to: perform a weighting operation to weight, about image data on white pixels and color pixels, color pixels surrounding a pixel of interest within a predetermined region in a manner such that a lower weight is attached to each of the color pixels as the color pixel is farther from the pixel of interest; and correct the pixel of interest if a sum of weights of the color pixels surrounding the pixel of interest is lower than a threshold.

### CROSS-REFERENCE TO RELATED APPLICATIONS

This application is based on and claims priority under 35 USC 119 from Japanese Patent Application No. 2023-143502 filed Sep. 5, 2023.

### BACKGROUND

### (i) Technical Field

The present disclosure relates to an information processing system, a non-transitory computer readable medium and an information processing method.

### (ii) Related Art

Japanese Unexamined Patent Application Publication No. 2019-149786 discloses a technique of acquiring an output image having a better granularity when a binary image is converted into a higher-resolution image. The technique modifies a ratio of color dots to white dots assigned to a color pixel of interest in accordance with a ratio of color pixels of a predetermined region including the color pixel of interest.

According to the technique disclosed in Japanese Unexamined Patent Application Publication No. 2019-149786, even when the numbers of color pixels in a second region larger than a predetermined region (hereinafter referred to as a first region) is almost equal to each other, a setting as to whether to correct a pixel of interest may be switched depending on a difference in the numbers of color pixels in the first region. This may lead to an uneven density.

In view of this this problem, a technique disclosed in Japanese Unexamined Patent Application Publication No. 2021-114662 examines the number of color pixels within the second region larger than the first region if the number of color pixels within the first region is lower than or equal to a predetermined value and determines the color pixel of interest as an isolated point and corrects the color pixel of interest if the number of color pixels within the second region is lower than or equal to a threshold. If the number of color pixels within the second region is higher than the threshold, the color pixel of interest is not corrected.

Although the technique disclosed in Japanese Unexamined Patent Application Publication No. 2021-114662 uses the two different regions and the basic idea of the disclosed technique determines, depending on the number of or ratio of color pixels within the predetermined regions, whether to correct the color pixel of interest (hereinafter referred to as a pixel of interest).

If an image binarized through error diffusion or other technique is printed on a printer having a higher dot gain, the size of each dot printed in response to a pixel of the image becomes larger and a dot substantially larger than the pixel is printed. For this reason, as a color pixel surrounding a pixel of interest is closer to the pixel of interest, the dot of the color pixel is more likely to overlap the dot of the pixel of interest.

If none of the dots of the surrounding color pixels overlaps the dot of the pixel of interest, the pixel of interest is easily noticeable as an isolated point and granularity looks inferior. In such a case, necessity to make correction on the isolated point is higher. However, an isolated point correction is not performed if the number of or ratio of the color pixels within a region is higher than a threshold and the isolated point correction is performed if the number of or ratio of the color pixels is lower than the threshold. Even with this method, the isolated point correction is not performed if the number of farther color pixels higher than the threshold is present within the region.

### SUMMARY

Aspects of non-limiting embodiments of the present disclosure relate to obtaining a better granularity image than the method that controls a determination as to whether to correct a pixel of interest in accordance with the number of or ratio of color pixels within a predetermined region including the pixel of interest.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: perform a weighting operation to weight, about image data on white pixels and color pixels, color pixels surrounding a pixel of interest within a predetermined region in a manner such that a lower weight is attached to each of the color pixels as the color pixel is farther from the pixel of interest; and correct the pixel of interest if a sum of weights of the color pixels surrounding the pixel of interest is lower than a threshold.

### BRIEF DESCRIPTION OF THE DRAWINGS

Exemplary embodiment of the present disclosure will be described in detail based on the following figures, wherein:

FIG. 1 illustrates an example of an entire functional configuration of an image processing apparatus;

FIG. 2 illustrates an example of a weight distribution;

FIGS. 3A and 3B illustrate an example of an arrangement of color pixels within a region;

FIG. 4 illustrates another example of the arrangement of the color pixels within the region;

FIG. 5 illustrates another example of the weight distribution;

FIG. 6 illustrates another example of the arrangement of the color pixels within the region;

FIG. 7 illustrates an example of a functional configuration of a resolution converter;

FIG. 8 illustrates an example of a procedure of the resolution converter;

FIG. 9 illustrates an example of the arrangement of the color pixels in color images and a multi-color image into which the color images are combined;

FIG. 10 illustrates an example of a threshold process performed to process the multi-color image;

FIG. 11 illustrates an example of a functional configuration of the image processing apparatus including a weight setting user interface (UI); and

FIG. 12 illustrates an example of a hardware configuration of a computer that implements an information processing system.

### DETAILED DESCRIPTION

Exemplary embodiment of the disclosure is described below with reference to the drawings.

Entire Configuration of Image Processing system

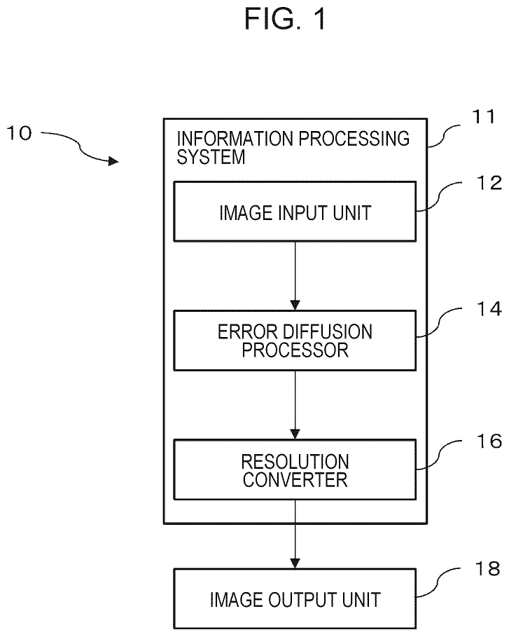

FIG. 1 illustrates an example of the entire functional configuration of an image processing apparatus 10. The image processing apparatus 10 may be an apparatus having a print function, such as a printer, a copying machine, a multi-function apparatus (having functions of a printer, scanner, copying machine, facsimile and/or other apparatuses). The image processing apparatus 10 includes an information processing system 11 and image output unit 18. The information processing system 11 is a functional module that performs an information processing process, such as image processing, on input image data. The image output unit 18 is a printer and prints the input image data onto a recording medium (hereinafter referred to as “paper sheet”) and outputs the printed paper sheet. The print method of the image output unit 18 is not limited to any method and, for example, may be an electrophotographic system or ink-jet system.

The information processing system 11 includes an image input unit 12, error diffusion processor 14 and resolution converter 16.

The image input unit 12 receives the input image data as a target. The image input unit 12 is a scanner that optically reads an original document and converts the read document into digital data. The image input unit 12 may be an external apparatus, such as a computer, and receive an image data file transmitted via a network or the like. When the image data file is received, the image input unit 12 converts the image data included in the file to a bit-map image.

If the image data input to the image input unit 12 is different in color space from an image output unit 18, the image input unit 12 performs color conversion on the input image data to cause the input image data to match the color space of the image output unit 18. For example, if the input image data is in a red-green-blue (RGB) format and the image output unit 18 supports a cyan-magenta-yellow-black (CMYK), the image input unit 12 performs the color conversion from the RGB format to the CMYK format.

The image data transferred from the image input unit 12 to the error diffusion processor 14 is bit-map image data of multi values (for example, 8 bits per each color) represented in the color space of the image output unit 18.

The error diffusion processor 14 converts the multi-valued image data into binary image data by performing an error diffusion process of related art on the multi-valued image data input from the image input unit 12. For example, if the input image data is CMYK multi-valued image data, the error diffusion processor 14 converts a multi-valued image of each of the CMYK colors into binary image data. The binary image data of each color is an image represented by white pixels having a density of zero and color pixels having a predetermined density.

The resolution converter 16 converts the binary image data of each color output from the error diffusion processor 14 into image data of a resolution of the image output unit 18. The resolution of the binary image data of each color output from the error diffusion processor 14 is equal to the resolution of the image data input to the image input unit 12. On the other hand, the resolution of the image output unit 18 performing printing may be occasionally higher than the resolution of the input image data. The resolution converter 16 thus performs resolution conversion on the binary image data resulted through the error diffusion.

The resolution of the image data to be input to the resolution converter 16, namely, the resolution of the binary image data output from the error diffusion processor 14 is referred to as an input resolution and the resolution of the image data output from the resolution converter 16 is referred to as an output resolution. The input resolution is equal to the resolution of the image data input to the image input unit 12. The output resolution is equal to the resolution of the image output unit 18. In the following discussion, the image data to be input to the resolution converter 16 is referred to as input image data and the image data output from the resolution converter 16 is referred to as output image data. Each pixel for the input image data is referred to as an input pixel while each pixel for the output image data is referred to as an output pixel.

The resolution converter 16 also performs the isolated point correction during the resolution conversion. The isolated point correction lowers the density of a color pixel that is isolated. Specifically, upon detecting a color pixel as an isolated point in the input image data, the resolution converter 16 performs the correction on the color pixel to lower the density of the color pixel.

The resolution converter 16 performs the isolated point correction as described below.

It is contemplated now that the resolution converter 16 converts a single input pixel into m×n output pixels of m rows and n columns (m and n are integers equal to 1 or higher). The area of each of the output pixels is 1/(m×n) the area of each of the input pixels. If one of m and n is 2 or higher, the resolution of the output image data is higher than the resolution of the input image data. For example, if a single input pixel is converted into a group of output pixels of 2 rows and 4 columns, the number of pixels of the output image data is 8 times the number of pixels of the input image data.

The resolution converter 16 converts each of the input pixels other than the isolated point into a group of m rows and n columns of output pixels, each output pixel having a value equal to the value of the input pixel. For example, if an input pixel that is not an isolated point is a white pixel, the resolution converter 16 converts the input pixel into a group of m xn white output pixels. If an input pixel that is not an isolated point is a color pixel, the resolution converter 16 converts the input pixel into a group of m×n color output pixels. The density of each color output pixel is equal to the density of the color pixel as the input pixel. The input pixels other than the isolated point thus remain unchanged in terms of density through the resolution conversion.

Upon determining that the input pixel is an isolated point (namely, an isolated color pixel), the resolution converter 16 lowers density by changing at least one or more output pixels from a group of m rows and n columns of output pixels to a white pixel. A color pixel, if not an isolated point, is converted into the color pixel group of m rows and n columns of color pixels while a color pixel, if an isolated pixel, is converted into the color pixel group of m rows and n columns of color pixels including at least one white pixel. As a result, the density is lowered. A predetermined rule may be applied to determine which of the pixels from the group of the m rows and n columns of color pixels is to be replaced with a white pixel. A determination method of the isolated point of the exemplary embodiment is described in greater detail below.

The output image data output from the resolution converter 16 is supplied to the image output unit 18. The image output unit 18 outputs an image onto a paper sheet in accordance with the output image data.

### Determination Method of Isolated Point

A determination as to whether a color pixel of interest in the input image data is an isolated point has been performed in the related art based on the number of color pixels within a region of a predetermined size surrounding the color pixel of interest.

According to the exemplary embodiment, in contrast, a color pixel surrounding the color pixel of interest is attached with a lower weight as the color pixel is farther from the color pixel of interest and the determination as to whether the color pixel of interest is an isolated point is then performed based on the sum of the weights of the surrounding color pixels. Each of the weights herein is 0 or higher.

If the sum of the weights of the color pixels surrounding the pixel of interest is lower than a predetermined threshold in the exemplary embodiment, the pixel of interest is determined to be an isolated point. A color pixel farther from the pixel of interest has a lower weight, in other words, a color pixel closer to the pixel of interest has a higher weight and thus, as the number of color pixels closer to the pixel of interest is more, the sum of weights is higher and the pixel of interest is less likely to be determined as an isolated point.

On the contrary, if no color pixels are present closer to the pixel of interest, the pixel of interest is more likely to be determined as an isolated point. For example, if there are relatively a high number of color pixels farther from the pixel of interest with no color pixels near the pixel of interest at all, the dots of the surrounding color pixels do not overlap the dot of the pixel of interest. In such a case, the pixel of interest tends to be outstanding as an isolated point and may be a target for the isolated point correction.

Based on this idea, the resolution converter 16 calculates the sum of the weights of color pixels surrounding the pixel of interest and compares the sum with the threshold to determine whether to perform the isolated point correction on the pixel of interest.

### Example of Weighting

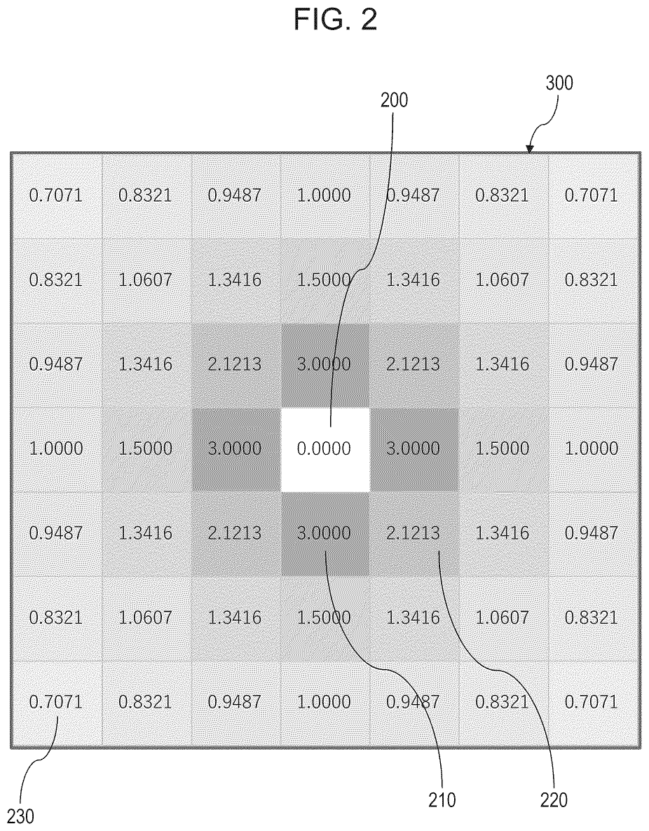

FIG. 2 illustrates an example of weighting of how a pixel group surrounding the pixel of interest is weighted. FIG. 2 illustrates weights of pixels including pixels 210 and 220 within a region 300 of 7×7 pixels centered on a pixel of interest 200. In this example, weight Wij of each pixel position (i,j) is calculated in accordance with the following equation:

Wij=1/(i²+j²)^{1/2}×3.

Here, i and j respectively refer to an x coordinate and y coordinate of each pixel position with the position of the pixel of interest 200 at the origin (0, 0). For example, an x coordinate to the right of the origin is a positive value, an x coordinate to the left of the original is a negative value, a y coordinate above the origin is a positive value and a y coordinate below the origin is a negative value. In accordance with the equation, the weight Wij is inversely proportional to a distance from the pixel of interest and the constant of proportion thereof is 3. The relationship of the weight inversely proportional to the distance and the constant of proportion of 3 is referred to for exemplary purposes only.

Since the pixel of interest 200 is not included in the sum of weights in FIG. 2, the weight of the pixel of interest 200 is zero, the weight of a pixel position 210 right below the pixel of interest 200 is 3.0000 and the weight of a pixel position 220 at the lower right position of the pixel of interest 200 is 2.1213. The weight of a pixel position 230 of the pixel that is at the lower left corner of the region 300 and farthest from the pixel of interest 200 is 0.7071.

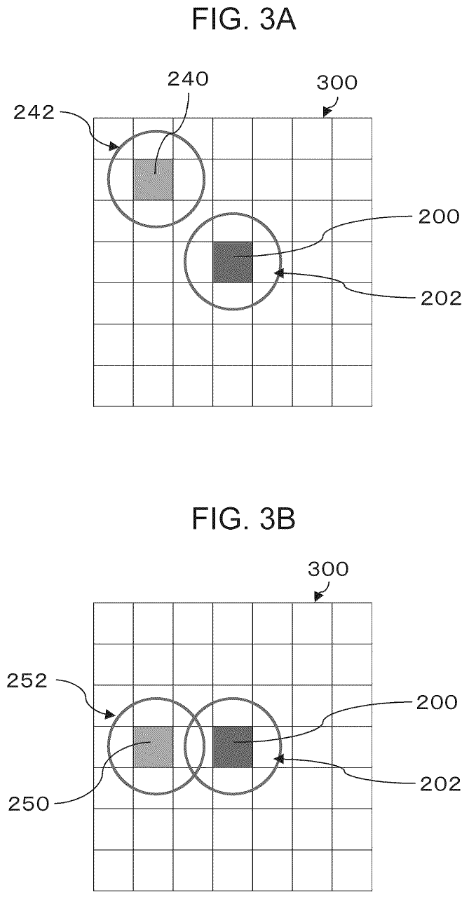

Described with reference to FIGS. 3A and 3B is an example of the determination as to whether the isolated point correction is to be performed in accordance with the weight distribution in FIG. 2. FIGS. 3A and 3B illustrate the region 300 of 7×7 pixels centered on the pixel of interest 200. Whether to correct the pixel of interest 200 is determined in accordance with the sum of the weights of the color pixels within the region 300. Referring to FIG. 3A, a single color pixel 240 is present at coordinates (−2, 2) in the region 300 and referring to FIG. 3B, a single color pixel 250 is present at coordinates (−2, 0) in the region 300.

A circle 202 denotes an outer circle of a dot created when the image output unit 18 prints the pixel of interest 200. Specifically, if the image output unit 18 prints the pixel of interest 200 without the isolated point correction, a solid dot of the circle 202 filled with ink of the color pixel is formed at the position of the pixel of interest 200 on a paper sheet. Similarly, a circle 242 denotes an outer circle of a dot created when the image output unit 18 prints the color pixel 240 and a circle 252 denotes an outer circle of a dot created when the image output unit 18 prints the color pixel 250. In this example, since a printed dot has a radium twice as long as a radius of a dot in the input image data (the dot is a circle having an area approximately equal to the area of each pixel in FIGS. 3A and 3B), dot gain of the image output unit 18 is 2.

The term “dot gain” is one of characteristics of a printer and signifies a magnification indicating how many times the size of a single color pixel (namely, a dot) in an input image is printed. In other words, the dot gain is a ratio of the size (for example, a radius) of an output dot to the size of the dot in the input image. As the dot gain is higher, the color pixel in the input image becomes larger in size on an output image on the paper sheet.

Referring to FIGS. 3A and 3B, the weight distribution in FIG. 2 is used and the threshold in the determination as to whether to perform the isolated point correction is 1.5. Specifically, if the sum of the weights of the color pixels in the region 300 is lower than 1.5, the isolated point correction is determined to be performed and if the sum of the weights of the color pixels in the region 300 is higher than or equal to 1.5, the isolated point correction is determined not to be performed.

Referring to FIG. 3A, since the color pixels within the region 300 include only the color pixel 240, the sum of the weights of the color pixels within the region 300 is equal to a weight of 1.0607 of the color pixel 240 and is lower than 1.5. The pixel of interest 200 is thus determined to be corrected.

In contrast, referring to FIG. 3B, the sum of the weights of the color pixels within the region 300 is equal to a weight of 1.5000 of the color pixel 250 and is thus higher than the threshold value of 1.5. The pixel of interest 200 is thus determined not to be corrected.

Referring to FIG. 3A, the dot of the pixel of interest 200 having the circle 202 as an outer circumference does not overlap the dot of the surrounding color pixel 240 (the outer circumference of this dot is a circle 242) and referring to FIG. 3B, the dot of the pixel of interest 200 overlaps the surrounding color pixel 250 (the outer circumference of this dot is the circle 252). The pixel of interest 200 has thus a higher degree of isolation from the surrounding color pixels in the example illustrated in FIG. 3A than in the example illustrated in FIG. 3B. If one color pixel 240 or one color pixel 250 is included in the region 300, the pixel of interest 200 is more likely to be determined to be corrected as the color pixel 240 or the color pixel 250 is farther from the pixel of interest 200.

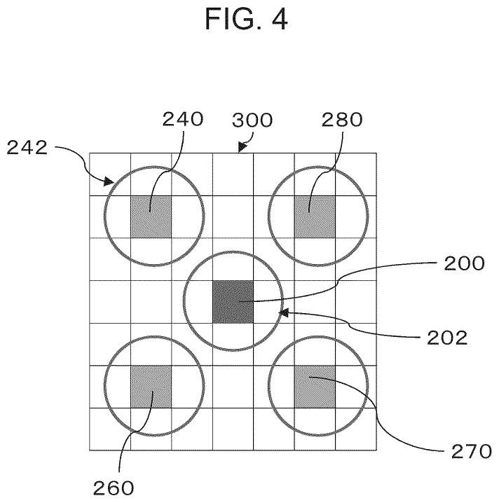

The combination of the weight distribution (see FIG. 2) and the threshold of 1.5 used in the examples in FIGS. 3A and 3B has been described for exemplary purposes only. The combination may not necessarily lead to the correction meeting a user's request. Such a case is described with reference to FIG. 4.

In the example illustrated in FIG. 4, four color pixels 240, 260, 270 and 280 are respectively present at coordinates (−2, 2), (−2,−2), (2,−2) and (2, 2) within the region 300. In accordance with the same weight distribution and threshold as those used in the examples in FIGS. 3A and 3B, the sum of weights within the region 300 is 1.0607×4=4.2428 and thus higher than the threshold of 1.5. The pixel of interest 200 is thus determined not to be corrected.

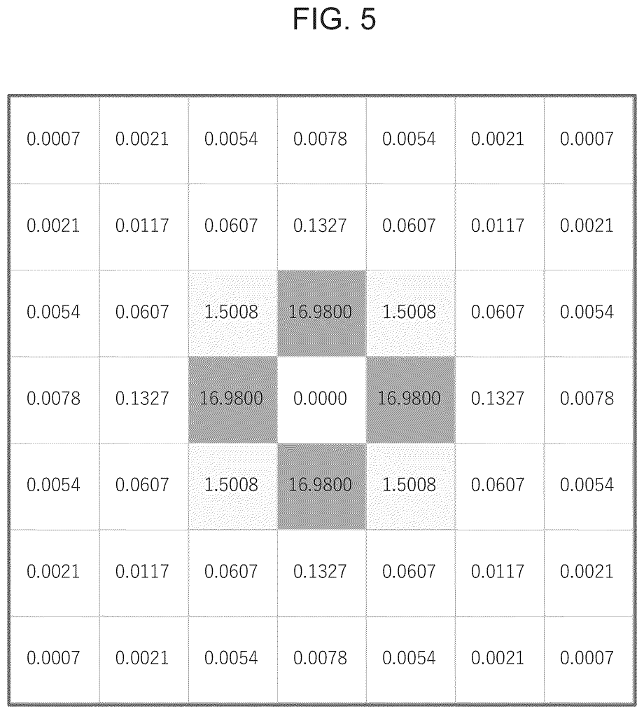

None of the dots with the four color pixels 240, 260, 270 and 280 printed overlaps the dot of the pixel of interest 200. A choice between whether the isolated point correction is performed in view of the absence of dots overlapping the dot of the pixel of interest 200 or not performed in view of a higher level of color surrounding the pixel of interest 200 may be determined depending image quality requested by the user. The isolated point correction to be performed on the pixel of interest 200 in FIG. 4 may involve a combination of the weight distribution and threshold different from the combination described above. For example, the weight distribution illustrated in FIG. 5 and the threshold of 1.5 may be used. In this case, even simply modifying the weight distribution may lead to such a combination.

The weight distribution in FIG. 5 is calculated in accordance with the following equation:

Wij={1/(i²+j²)^{1/2}}7×16.98.

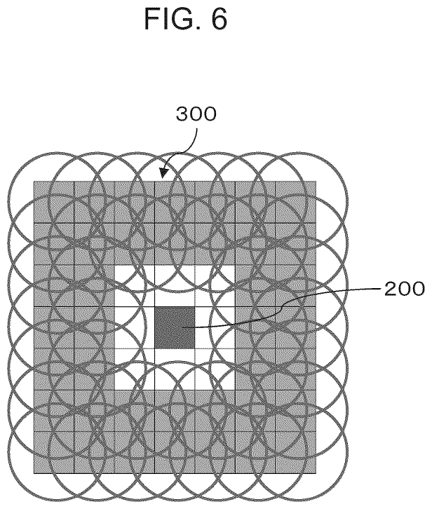

In the example illustrated in FIG. 5, the weight Wij of each pixel is the reciprocal of a distance from the pixel of interest 200 to the seventh power multiplied by a constant of proportion of 16.98. This weight is inversely proportional to the distance to the seventh power and thus sharply decreases as the distance from the pixel of interest 200 increases. When the weight distribution is used, the sum of the weights of the color pixels is 1.1574 even if a pixel group surrounding the 3×3 pixels centered on the pixel of interest 200 is all color pixels as illustrated in FIG. 6. Since the sum of 1.1574 is lower than the threshold of 1.5, the isolated point correction is determined to be performed on the pixel of interest 200. In the example in FIG. 4 having a lower number of color pixels than in the example in FIG. 6, the isolated point correction is determined to be performed.

### Process of Resolution Conversion

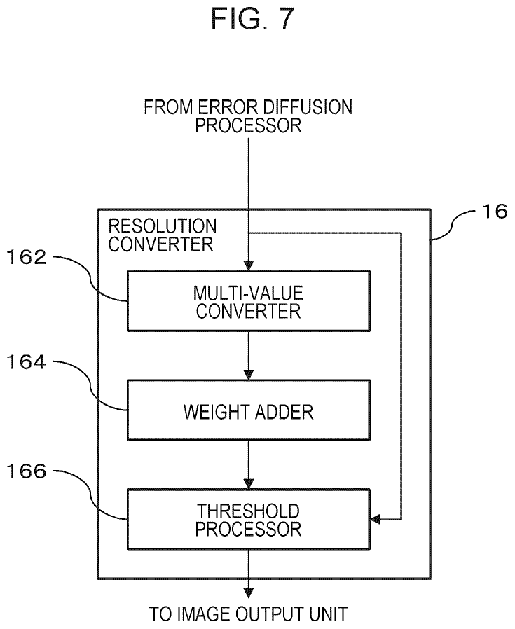

The idea of determining whether to perform the isolated point correction using the weight distribution and threshold has been described. An example of the internal configuration of the resolution converter 16 based on the idea is described with reference to FIG. 7.

The resolution converter 16 illustrated in FIG. 7 includes a multi-value converter 162, weight adder 164 and threshold processor 166.

The multi-value converter 162 converts a value of each pixel in binary image data input from the error diffusion processor 14 into multiple values. This conversion is performed to convert the value of each pixel to the same real numbers as a weight such that the weight adder 164 multiplies the value of the pixel by the weight. For example, if a binary image is converted into a 8-bit multi-value, the multi-value converter 162 converts the value of a white pixel in the binary image (namely, a value of 0) into a 8-bit value representing a real value of 0.0 and the value of a color pixel in the binary image (namely, a value of 1) into a 8-bit value representing a real value 1.0. Specifically, the multi-value converter 162 practically converts the binary image of 0 and 1 into a multi-bit image, practically, into a binary image of 0.0 and 1.0.

With each pixel of the multi-valued image data output from the multi-value converter 162 being set to the pixel of interest, the weight adder 164 calculates, on a per pixel basis, the sum of the weights of the color pixels surrounding the pixel of interest.

The threshold processor 166 compares the sum of the weights calculated by the weight adder 164 with the threshold to determine whether to perform the isolated point correction on the pixel of interest and generates an output corresponding to the pixel of interest in response to the determination results. In the generation of the output, the threshold processor 166 converts a single pixel of interest into a matrix of multiple output pixels. Through this operation, the input image data is converted into output image data of a higher resolution.

In the conversion described above, with respect to the pixel of interest determined not to undergo the isolated point correction, the threshold processor 166 outputs a pixel group of m×n pixels having the same value as the value of the pixel of interest (namely, 0 or 1). Specifically, if the pixel of interest is a white pixel, the threshold processor 166 outputs a white output pixel group of m×n pixels and if the pixel of interest is a color pixel, the threshold processor 166 outputs a color pixel group of m×n pixels. With respect to the pixel of interest determined to undergo the isolated point correction, the threshold processor 166 outputs the output pixel group with several pixels thereof modified to a white pixel in accordance with a predetermined rule.

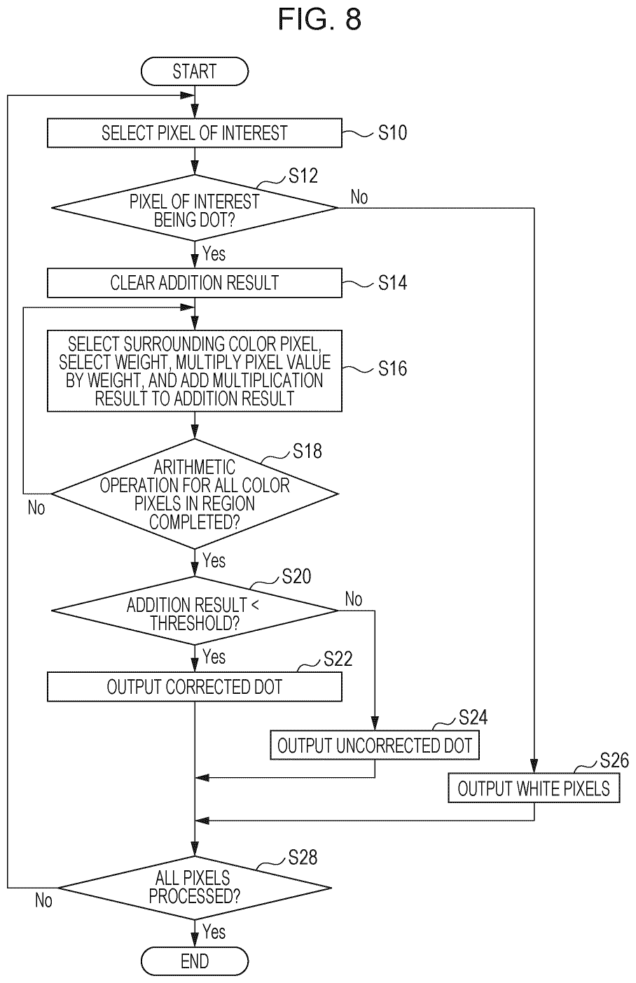

FIG. 8 illustrates the procedure of a process performed by the weight adder 164 and threshold processor 166. The following discussion also refers to FIGS. 3A and 3B.

In the process illustrated in FIG. 8, the weight adder 164 selects a pixel of interest 100 from the input image data in accordance with a predetermined order (step S10). The weight adder 164 determines whether the selected pixel of interest 100 is a dot (namely, a color pixel) (S12). If the pixel of interest 100 is not a dot, in other words, if the pixel of interest 100 is a white pixel, the threshold processor 166 outputs a white pixel group of m×n pixels as an output pixel group corresponding to the pixel of interest (S26).

Upon determining in S12 that the pixel of interest 100 is a dot, the weight adder 164 clears the value of the addition results stored as an internal variable (S14). The weight adder 164 examines the pixels surrounding the pixel of interest 100 within the region 300 in a predetermined order and if a color pixel is detected, the weight adder 164 determines the position of the color pixel from the weight distribution (for example, in FIG. 2 or 5). The weight adder 164 multiplies the value of the color pixel by the weight of the color pixel and adds the multiplication result to addition result (S16). The weight adder 164 determines whether all the pixels within the region 300 have been examined (S18) and if there is still an unexamined pixel, processing returns to S16 to process the unexamined pixel.

If the examination of all the pixels is determined to be completed in S18, the addition result serving as the internal variable includes the sum of the multiplication results of the values of the color pixels within the region 300 and the weights of the color pixels. Since the value of each color pixel is a real value of 1.0, the final addition result is the sum of the weights of the color pixels within the region 300. The weight adder 164 transfers the final addition result to the threshold processor 166.

The threshold processor 166 determines whether the final addition result is lower than the threshold (S20). If the addition result is lower than the threshold (the determination result in S20 is yes), the threshold processor 166 outputs a dot group corrected through the isolated point correction as an output pixel group corresponding to the pixel of interest (S22). In other words, the threshold processor 166 determines that the pixel of interest is an isolated point and then performs the isolated point correction. If the operation in S22 is performed, the pixel of interest is a dot (namely, a color pixel). If the isolated point correction is not performed, the threshold processor 166 outputs a dot group of m×n pixels as resolution conversion results. Since the isolated point correction is herein performed in S22, the threshold processor 166 converts, into a white dot, a predetermined one or more dots in the dot group of m×n dots defined by an isolated point correction rule and then outputs the white dot. In this way, a density of the output pixel group corresponding to the pixel of interest may be lower than when the isolated point correction is not performed.

The intensity of the isolated point correction may be modified in accordance with the final addition result, namely, the sum of the weights in S22. Specifically, as the value of the final addition result is lower, the density of the pixels surrounding the pixel of interest is lower and thus the number of pixels to be converted into the white pixels in the output pixel group may be increased such that the density of the pixels of interest is set to be lower through the isolated point correction.

If the determination result in S20 is no, in other words, if the final addition result is the threshold or higher, the threshold processor 166 outputs as a result of the resolution conversion the dot group of m×n dots corresponding to the pixel of interest (S24). In this case, the isolated point correction is not performed on the pixel of interest.

Subsequent to S22, S24 or S26, the weight adder 164 determines whether all the pixels of the input image data have undergone the operations in S10 through S26 (S28). If the determination result in S28 is no, the weight adder 164 returns to S10, selects the next pixel of interest from the input image data and performs S12 and subsequent steps on that pixel of interest.

If the determination result in S28 is yes, the process of the resolution conversion on the input image data is complete.

As described above, according to the exemplary embodiment, a color pixel is attached with a lower weight as the distance of the color pixel is farther from the pixel of interest and if the sum of the weights of the color pixels surrounding the pixel of interest is lower than the threshold, the isolated point correction is performed on the pixel of interest. This method may implement a fine determination in comparison with the case where whether to perform the isolated point correction is determined based on the number of the color pixels surrounding the pixel of interest.

### Process on Multi-Color Image

FIG. 8 illustrates the procedure be performed on a single color image. In contrast, a process of a multi-color image, such as a full-color image, involves considering an image of multi-color.

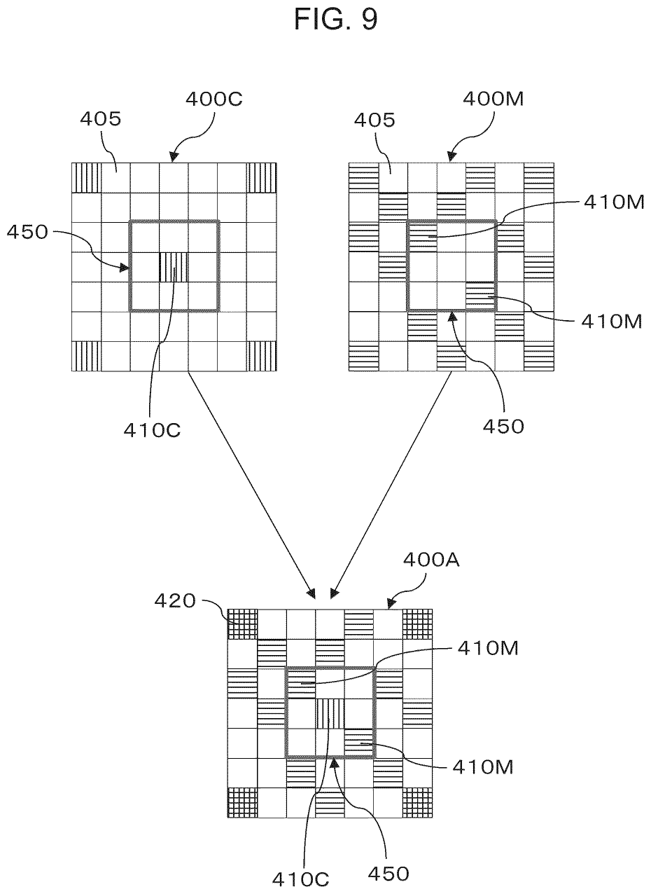

In the process of the multi-color image, a dot of the pixel of interest of an image of one color is an isolated point and a dot of another color may be closer to the pixel of interest. In such a case, if the isolated point correction is performed on the pixel of interest, granularity remains unchanged. If the isolated point correction is performed in such a case, balance between the color of the pixel of interest and the surrounding dots of the other color is lost, causing the color to look different. FIG. 9 illustrates this example.

Referring to FIG. 9, an image 400C is a portion of a cyan version of an image and an image 400M is the corresponding portion of a magenta version of the image. The image 400C and image 400M are binary images after the error diffusion process. The image 400C includes white pixels 405 and cyan pixels 410C of a predetermined density. The image 400M includes white pixels 405 and magenta pixels 410M of a predetermined density. An image 400A is a multi-color image into which the image 400C and image 400M are combined.

The cyan pixel 410C at the center of the image 400C of 7×7 pixels is set to be the pixel of interest and a determination as to whether the pixel of interest is an isolated point may now be determined. For convenience of explanation, if a region 450 of 3×3 pixels surrounding the pixel of interest includes one or more color pixels, the pixel of interest is determined not to be an isolated point and if the region 450 of 3×3 pixels surrounding the pixel of interest includes none of the color pixels, the pixel of interest is determined to be an isolated point. With respect to the image 400C of the cyan version in FIG. 9, an area of the region 450 surrounding the cyan pixel 410C at the center serving as the pixel of interest includes only the white pixels and no cyan pixels. In view of only the image 400C, the pixel of interest is determined to be an isolated point. With respect to the image 400M of the magenta version, the region 450 includes two magenta pixels 410M surrounding the pixel of interest. A multi-color image 400A includes four corner pixels 420 of a composite color of cyan and magenta. In the multi-color image 400A, magenta pixels 410M are present at the upper left and lower right of the central cyan pixel 410C (the pixel of interest). In this case, if the density of cyan of the pixel of interest is lowered by performing the isolated point correction on only the image 400C of the cyan version, color balance with nearby magenta pixels 410M may become different from the color balance of the original image.

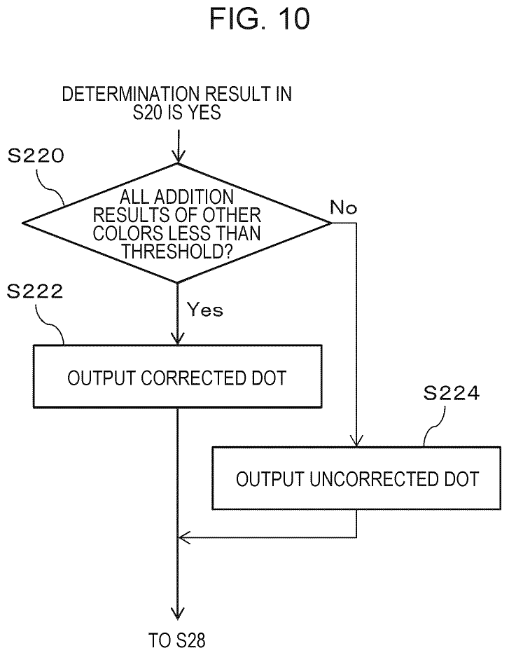

In view of the example described above, when the isolated point correction is performed on the pixel of interest of one color, the resolution converter 16 accounts for the color pixels surrounding the pixel of interest of another color version. The procedure to be performed by the resolution converter 16 in this case is illustrated in FIG. 10 where the operation in S22 in FIG. 8 is replaced with operations in S220 through S224 in FIG. 10. The process is described below with reference to FIG. 10.

In the procedure, the resolution converter 16 performs on each of the color versions the process illustrated in FIG. 8 (but with the operation in S22 replaced with S220 through S224 in FIG. 10). The process is performed in parallel on each of the color versions and when S220 illustrated in FIG. 10 starts, the operations in S10 through S20 are completed on all the color versions. Specifically, the final addition result (namely, the sum of weights) has been obtained on each of the color pixels surrounding the pixel of interest.

If the final addition result on the color pixels surrounding the pixel of interest of one color is determined to be lower than the threshold in S20, the threshold processor 166 in the resolution converter 16 compares the final addition result calculated on each of the other colors with the threshold. The threshold processor 166 determines whether all the final addition results are lower than the threshold (S220). If the determination result in S220 is yes, the threshold processor 166 outputs an isolated-point corrected dot group as an output pixel group corresponding to the pixel of interest (S222). If the determination result in S220 is no, the threshold processor 166 outputs the dot group of m×n pixels, as it is, corresponding to the pixel of interest (S224). Subsequent to S222 or S224, the resolution converter 16 proceeds to the operation in S28.

As described above, although a pixel of interest is an isolated point in an image of the same color as the pixel of interest, the pixel of interest may not be an isolated point in view of an image of another color. In such a case, the isolated point correction is not performed. Such a process may control a degradation of the color balance.

### Designation of Weight Distribution by User

A weight distribution table used by the weight adder 164 may be modified in response to an instruction from the user. For example, the weight Wij may be defined by the following equation:

$$Wij = {\{ 1 / {( {i}^{2} + {j}^{2} )}^{1 / 2} \}}^{n} \times k .$$

A variety of weight distributions may be prepared by modifying parameters n and k in the definition in response to the instruction from the user. Here, n is a real number of 1 or higher and k is a positive real number. If a weight with n=1 and k=1 is set to be a standard weight, a number of weights may be generated by multiplying the standard weight to the n-th power by a constant of proportion k. The standard weight is cited herein for exemplary purposes only.

As the value of n increases in the example described herein, the degree of decrease of the weight becomes sharp in response to the distance from the pixel of interest 200 (see FIGS. 3A and 3B and 4). If a high number of color pixels are present farther from the pixel of interest 200 within the region 300, the value of n may be increased to perform the isolated point correction on the pixel of interest.

Simply increasing n causes the sum of weights to be lower than the threshold even when there are color pixels closer to the pixel of interest 200 and the isolated point correction may be performed on the pixel of interest. To control such an event, a higher value may simply set to the constant of proportion k.

The combination of the values of n and k determines what distribution of the color pixels surrounding the pixel of interest 200 causes the isolated point correction to be performed or not to be performed.

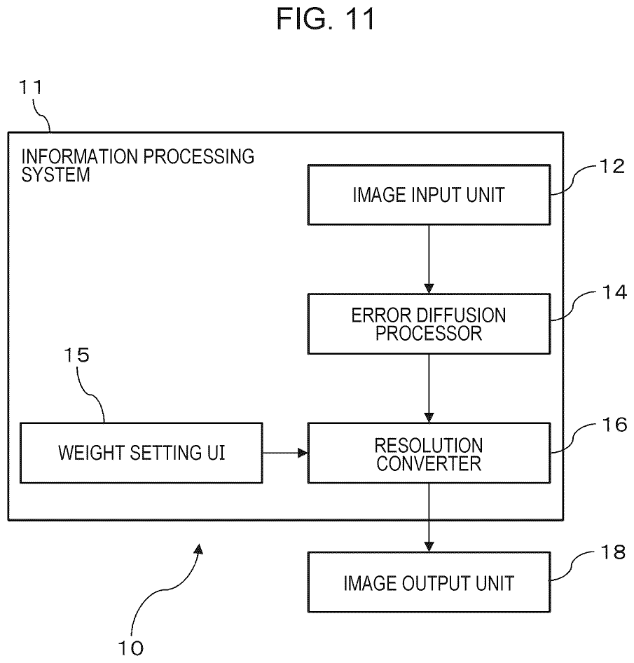

The information processing system 11 of the image processing apparatus 10 may include a setting user interface (UI) 15 that receives a setting of the weight distribution to satisfy an image quality (such as granularity) requested by the user (see FIG. 11). The UI 15 displays several images (images illustrated in FIGS. 3A and 3B, 4 and 6) different in the distribution of the color pixels within the region 300 on a display connected to the image processing apparatus 10. The UI 15 inputs on a per displayed image basis an instruction indicating whether to perform the isolated point correction on the pixel of interest 200 within the image. In response to a combination of instructions input by the user on each image, the UI 15 determines the values of n and k in the equation described above.

As described above, with a single standard weight distribution prepared, the weight distributions having a variety of characteristics may be generated by modifying the values of n and k.

### Selection of Threshold

The value of the threshold used to compare with the sum of the weights in S20 in the process in FIG. 8 may be changed depending on the bit gain of the image output unit 18. Specifically, the threshold is set to be lower as the dot gain of the image output unit 18 is higher. For example, the threshold may be inversely proportional to the dot gain. The resolution converter 16 stores a rule, a relational expression or a table, each representing the relationship between the dot gain and threshold, determines a threshold responsive to the dot gain of the image output unit 18 in accordance with the rule and uses the threshold in S20. For example, in order to perform the resolution conversion for an external printer, the image processing apparatus 10 acquires information on the dot gain of the printer via a network or the like from the printer, determines a threshold responsive to the dot gain in accordance with the rule or the like and uses the threshold in the procedure illustrated in FIG. 8 or the like.

A dot becomes larger as the dot gain is higher. A dot of a color pixel farther from a pixel of interest may overlap the dot of the pixel of interest. On the other hand, if a dot of a surrounding color pixel overlaps the pixel of interest, granularity may be better without performing the isolated point correction. Therefore, the granularity may be improved if the isolated point correction is less likely performed as the dot gain is higher. The threshold used in S20 is simply decreased such that the isolated point correction is less likely performed as the dot gain of the image output unit 18 or the external printer is higher.

The exemplary embodiment has been described for exemplary purposes only and a variety of changes may be implemented in the present disclosure without departing from the scope of the disclosure. For example, the image processing apparatus 10 binarizes the input multi-valued image data through the error diffusion but the technique of the binarization is not limited to this method. The multi-valued image data may be binarized through the dither method.

Referring to FIG. 1, the image processing apparatus 10 includes the image output unit 18 but may not necessarily include the image output unit 18. In such a case, the image processing apparatus 10 may receive an image to be printed by an external printer from a host device of the external printer, perform binarization and resolution conversion (including the isolated point correction) on the image in accordance with the technique of the exemplary embodiment and may supply the resulting image to the printer.

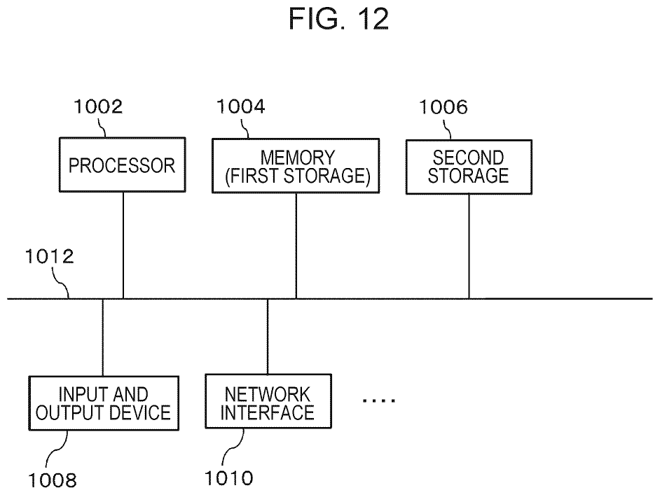

The information processing system 11 of the image processing apparatus 10 described above may be implemented using, for example, a general-purpose computer. The information processing system 11 has a circuit configuration illustrated in FIG. 12. The circuit configuration includes a processor 1002, memory (first storage) 1004, such as a random-access memory (RAM), a controller controlling a second storage 1006 serving as a non-volatile storage, such as a flash memory, a solid-state drive (SSD) or a hard disk drive (HDD), interface with an input and output device 1008 and a network interface 1010 controlling network connection with a local area network, with these elements interconnected to each other via a bus 1012 or the like. A program describing contents of the processes of the exemplary embodiment is installed onto the computer via the network and stored on the second storage 1006. The processor 1002 executes the program stored on the second storage 1006 using the memory 1004, thereby implementing an information processing mechanism of the exemplary embodiment. The information processing system 11 may include an image processor that performs general-purpose or specific image processing at a higher speed.

The information processing system 11 may include a single computer or multiple computers. For example, part of the function of the information processing system 11 may be implemented by another computer external to the image processing apparatus 10.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
a processor configured to:
   perform a weighting operation to weight, about image data on white pixels and color pixels, color pixels surrounding a pixel of interest within a predetermined region in a manner such that a lower weight is attached to each of the color pixels as the color pixel is farther from the pixel of interest; and
   correct the pixel of interest if a sum of weights of the color pixels surrounding the pixel of interest is lower than a threshold.
      (((2)))

In the information processing system according to (((1))), the processor is configured to:
calculate the weight that is attached to each of the color pixels surrounding the pixel of interest and is lower as the color pixel is farther from the pixel of interest, the weight being a standard weight to the n-th power (n is an integer equal to 1 or higher), the standard weight being a real number higher than or equal to 0 and lower than or equal to 1 and being lower as the color pixel is farther from the pixel of interest,
wherein a degree of decrease of the weight in response to a distance of the color pixel from the pixel of interest is modifiable by modifying n.
   (((3)))

In the information processing system according to one of (((1))) and (((2))), the processor configured to:
in accordance with a first color used in a printer printing the image data corrected by the information processing system,
perform the weighting operation on the image data including a white pixel and a color pixel of the first color;
calculate a sum of the weights of the color pixels surrounding the pixel of interest; and
with the calculated sum of the weights lower than the threshold, not correct the pixel of interest if the sum of the weights of the color pixels of a second color is higher than or equal to the threshold but correct the pixel of interest if the sum of the weights of the color pixels of the second color is lower than the threshold.
   (((4)))

In the information processing system according to one of (((1))) through (((3))), the processor is configured to use as the threshold a lower value as a dot gain of a printer printing the image data corrected by the information processing system is higher.

(((5)))

A program causing a computer to execute a process, the process including:
performing a weighting operation to weight, about image data on white pixels and color pixels, color pixels surrounding a pixel of interest within a predetermined region in a manner such that a lower weight is attached to each of the color pixels as the color pixel is farther from the pixel of interest; and
correcting the pixel of interest if a sum of weights of the color pixels surrounding the pixel of interest is lower than a threshold.

What is claimed is:

1. An information processing system comprising:
a processor configured to:
perform a weighting operation to weight, about image data on white pixels and color pixels, color pixels surrounding a pixel of interest within a predetermined region in a manner such that a lower weight is attached to each of the color pixels as the color pixel is farther from the pixel of interest; and
correct the pixel of interest if a sum of weights of the color pixels surrounding the pixel of interest is lower than a threshold.

2. The information processing system according to claim 1, wherein the processor is configured to:
calculate the weight that is attached to each of the color pixels surrounding the pixel of interest and is lower as the color pixel is farther from the pixel of interest, the weight being a standard weight to the n-th power (n is an integer equal to 1 or higher), the standard weight being a real number higher than or equal to 0 and lower than or equal to 1 and being lower as the color pixel is farther from the pixel of interest,
wherein a degree of decrease of the weight in response to a distance of the color pixel from the pixel of interest is modifiable by modifying n.

3. The information processing system according to claim 1, wherein the processor is configured to:
in accordance with a first color used in a printer printing the image data corrected by the information processing system,
perform the weighting operation on the image data including a white pixel and a color pixel of the first color;
calculate a sum of the weights of the color pixels surrounding the pixel of interest; and
with the calculated sum of the weights lower than the threshold, not correct the pixel of interest if the sum of the weights of the color pixels of a second color is higher than or equal to the threshold but correct the pixel of interest if the sum of the weights of the color pixels of the second color is lower than the threshold.

4. The information processing system according to claim 1, wherein the processor is configured to use as the threshold a lower value as a dot gain of a printer printing the image data corrected by the information processing system is higher.

5. A non-transitory computer readable medium storing a program causing a computer to execute a process comprising:
performing a weighting operation to weight, about image data on white pixels and color pixels, color pixels surrounding a pixel of interest within a predetermined region in a manner such that a lower weight is attached to each of the color pixels as the color pixel is farther from the pixel of interest; and
correcting the pixel of interest if a sum of weights of the color pixels surrounding the pixel of interest is lower than a threshold.

6. An information processing method comprising:
performing a weighting operation to weight, about image data on white pixels and color pixels, color pixels surrounding a pixel of interest within a predetermined region in a manner such that a lower weight is attached to each of the color pixels as the color pixel is farther from the pixel of interest; and
correcting the pixel of interest if a sum of weights of the color pixels surrounding the pixel of interest is lower than a threshold.
